(19) United States
(12) Patent Application Publication
(10) Pub. No.: US 2010/0312580 A1
(43) Pub. Date: Dec. 9, 2010

(54) SYSTEM FOR ASSISTING IN DRUG DOSE OPTIMISATION

(76) Inventors: Lionel Tarassenko, Oxford (GB); David J. Kerr, Oxford (GB); Annie Young, Gloucester (GB)

Correspondence Address: NIXON & VANDERHYE, PC, 901 NORTH GLEBE ROAD, 11TH FLOOR, ARLINGTON, VA, 22203, US

(21) Appl. No.: 12/734,332

(22) PCT Filed: Oct. 27, 2008
(86) PCT No.: PCT/GB2008/003618

§ 371 Date: Aug. 11, 2010

(30) Foreign Application Priority Data
Oct. 26, 2007 (GB) 072117.0

(51) Int. Cl. G06Q 50/00; G06F 17/30

(52) U.S. Cl. 705/3; 705/2; 707/758; 707/E17.009

(57) ABSTRACT

A system for assisting in dose optimisation for patients administering medication to themselves at home consists of a mobile telephone or PDA to which the patient is prompted to enter data indicative of their condition and also the dosage of medication they are taking. Such data is stored on the phone and transmitted to a remote server and is processed against predetermined criteria to decide whether the medication dose should be maintained or increased or decreased based on the patient's current condition. A message instructing the patient to maintain or adjust the dosage is displayed based on this determination. The data is made available both to the patient and clinicians by means of web pages provided by the remote server.

The present invention relates to a system for assisting in drug dose optimisation, also known as dosage titration, and in particular to a system which is well adapted to use by a patient administering their own medication at home.

In the treatment of illnesses and chronic conditions by use of medication it is normal for a clinician to set a dosage for the medication based on the clinician's own experience, taking into account the severity of the patient's condition and the patient's age, weight and gender and so on, and information derived from trials of the medication. The information from trials typically indicates a therapeutically-effective range, i.e. above dosages which have too little effect and below those which are dangerous. For example, in the treatment of cancer by chemotheraphy with cytotoxic drugs the dose definition stems from the Phase I trial where dose-limiting toxicity is characterised by the occurrence of severe side effects in a proportion of patients treated at that dose level. This is based on the premise that conventional cytotoxic drugs must induce a sufficient degree of cell kill in rapidly proliferating cell compartments (e.g. bone marrow, intestinal crypts, etc.), in order to be certain that the dose is within the therapeutic range. Typically dose modification schedules made available to clinicians describe rules for dose reduction in the face of unacceptable toxicity. But they do not include dose increases for those patients who suffer negligible toxicity. This means that the dose is not optimised for each patient.

In the treatment of chronic conditions a patient may be started with an initial dose, which is then adjusted over time by observation of the patient's response. However, in many cases this is a lengthy, time-consuming and rather inaccurate process. For example, in the treatment of a patient with Type II diabetes who needs to be initiated onto insulin, the patient will typically be given an initial dose and asked to take regular blood glucose readings. The patient will then be seen by the clinician on a regular basis every few weeks, the blood glucose levels (usually the fasting blood glucose levels) reviewed and the dose gradually increased provided that it does not cause hypoglycaemia. Typically it takes six to nine months to arrive at a correct insulin dosage for a patient. Similar periodic adjustments of medication are found in the treatment of other chronic conditions such as asthma (usage of step-up/step-down inhalers), hypertension (self-titration of anti-hypertensive drugs), etc. During the period of titration,

though, the patient may be over- or under-controlled which can be harmful for the patient.

According to the present invention there is provided a system for assisting in dose optimisation of medication, the system comprising:
a patient-based data processing terminal adapted to provide for periodic entry by the patient of predefined data indicative of their condition and of a current value of the dosage of medication associated with that condition that the patient is taking;
a data processor adapted to compare the entered data and dosage value with predefined criteria and to produce on the basis of the comparison a determination selected from adjusting or maintaining the dosage of medication;
a display adapted to display to a user a message based on said determination instructing the user to adjust or maintain the dosage of medication.

Thus with the present invention the patient is provided with a data processing terminal, which can be a familiar mobile telephone or telephony-enabled PDA, into which they can enter data indicative of their condition and based on that condition-indicative data they can receive advice on whether to maintain or adjust the dosage of medication. This allows the dosage to be adjusted much more frequently than with conventional care that relies on the patient visiting a clinician on a regular basis. Thus the dose can be titrated to the correct value much more quickly. Also, the value which is arrived at is based on the response of that particular patient to the medication and is thus optimised and personal for that patient.

The data processor performing the determination may be provided in the patient-based data processing terminal, in which case the message is displayed on a display in the patient-based data processing terminal, which facilitates a titration process conducted largely by the patient with little or no clinician input and is suitable for treatment of conditions such as asthma and hypertension. Alternatively it may be provided at a server remote from said patient-based data processing terminal, in which case the process may be mediated by a clinician who reviews the data prior to dose change, thus providing maximum safety for the patient, this arrangement being more suitable for chemotherapy dose titration. It should be understood, though, that in any of the cases drug dose optimisation can be performed at the patient-based data processing terminal or at the server as required, especially in the case of insulin dose titration.

In the case of use of a remote server the system is preferably adapted to communicate said entered data and dosage values to said remote server and to communicate said message back to said patient-based data processing terminal for display thereon. Preferably the system is adapted to display the message to said clinician before transmission to said patient-based data processing terminal.

Preferably the patient-based data processing terminal comprises a data store which is adapted to store the entered dosage values. The data is also preferably transmitted to a remote server, from where it can be inspected by a clinician and also made available to a patient via a web page. Further the patient-based data processing terminal can maintain a record of the currently recommended dose and, if the patient enters data indicating that they are taking a different dose, ask the patient to confirm the dose and optionally alert the clinician.

Preferably the patient-based data processing terminal is adapted to display to the patient a record of their condition and of the dosage of medication taken, with the good condition (e.g. no hypoglycaemia in diabetes or no symptoms in chemotherapy) and bad condition data (e.g. hypoglycaemia in diabetes or high-grade toxicity in chemotherapy) being visually distinguishable, e.g. in different colours.

The determination to adjust the dosage can be to increase or decrease the dose, and furthermore the determination can be to increase the dose by varying amounts depending on the comparison of the entered data and dosage value with the predefined criteria. This allows the dosage to be adjusted in coarser steps when the condition departs significantly from the desired condition, but with finer steps as the patient approaches the desired condition.

The predefined condition-indicative data can be objective data such as the results of measurements, e.g. of blood glucose level, peak flow, blood pressure, temperature, or the results of subjective self-assessments as to the severity of pre-defined symptoms such as nausea, diarrhoea, etc. Where the data is the result of a measurement, the measurement may be transmitted directly from the measuring device (for example a glycometer) to the patient-based data processing terminal.

The invention also provides a system including a plurality of such patient-based data processing terminals and a remote server. The patient-based data processing terminals transmit the data on patient condition and dosage to the remote server and the remote server makes that data available to one or more clinicians who are responsible for the patient's care. The server may also make web pages available to the patients to give them more detailed indication of their condition than is available on the patient-based data processing terminal itself. Preferably the server is adapted to send data to the clinicians periodically in batches, though alerts may be sent in the event of data from a particular patient-based data processing terminal indicating a condition requiring their attention.

The invention will be further described by way of example with reference to the accompanying drawings in which:—

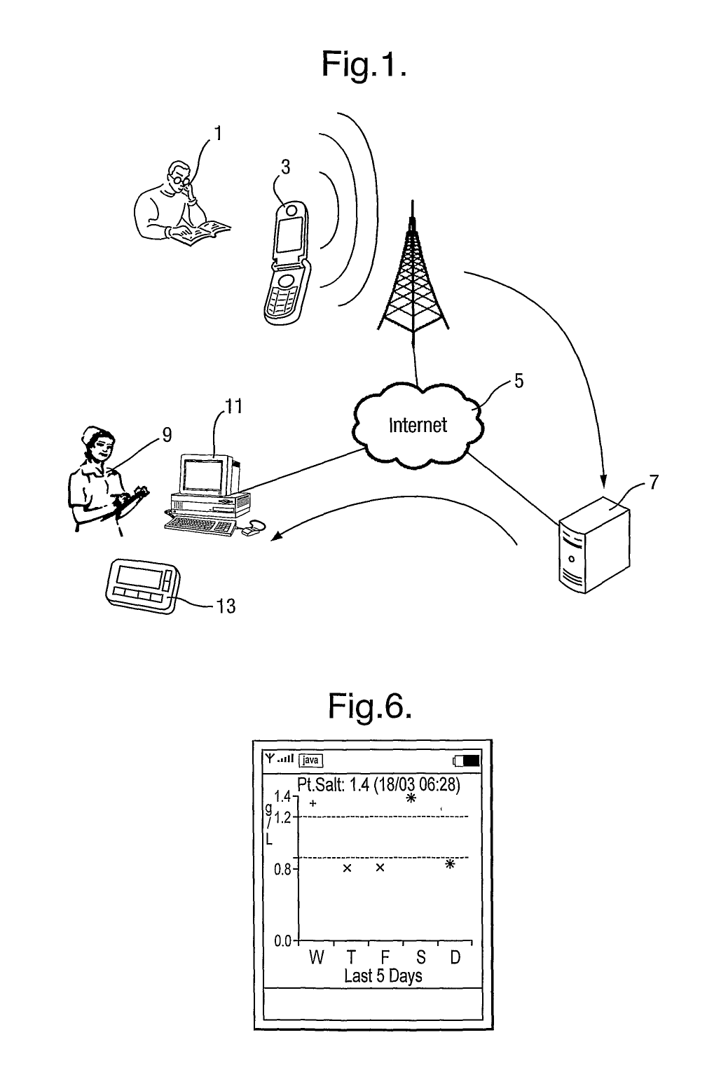

FIG. 1 schematically illustrates a system in accordance with an embodiment of the invention;

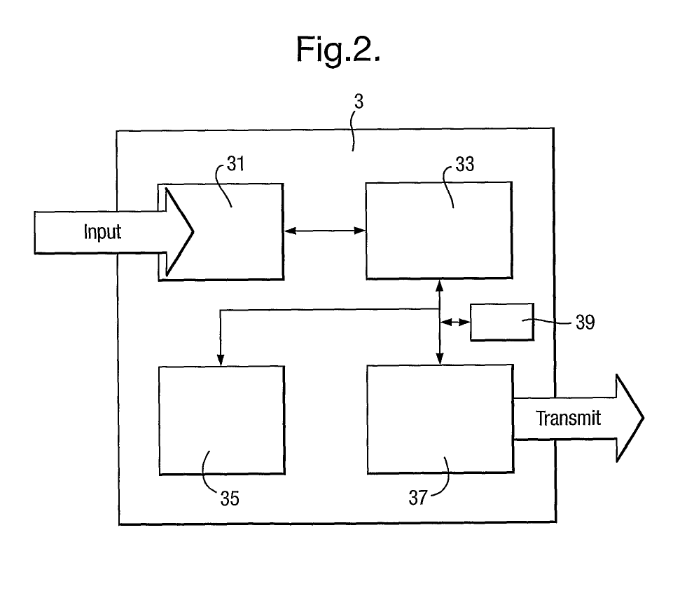

FIG. 2 is a block diagram schematically illustrating a patient-based data processing terminal in accordance with one embodiment of the invention;

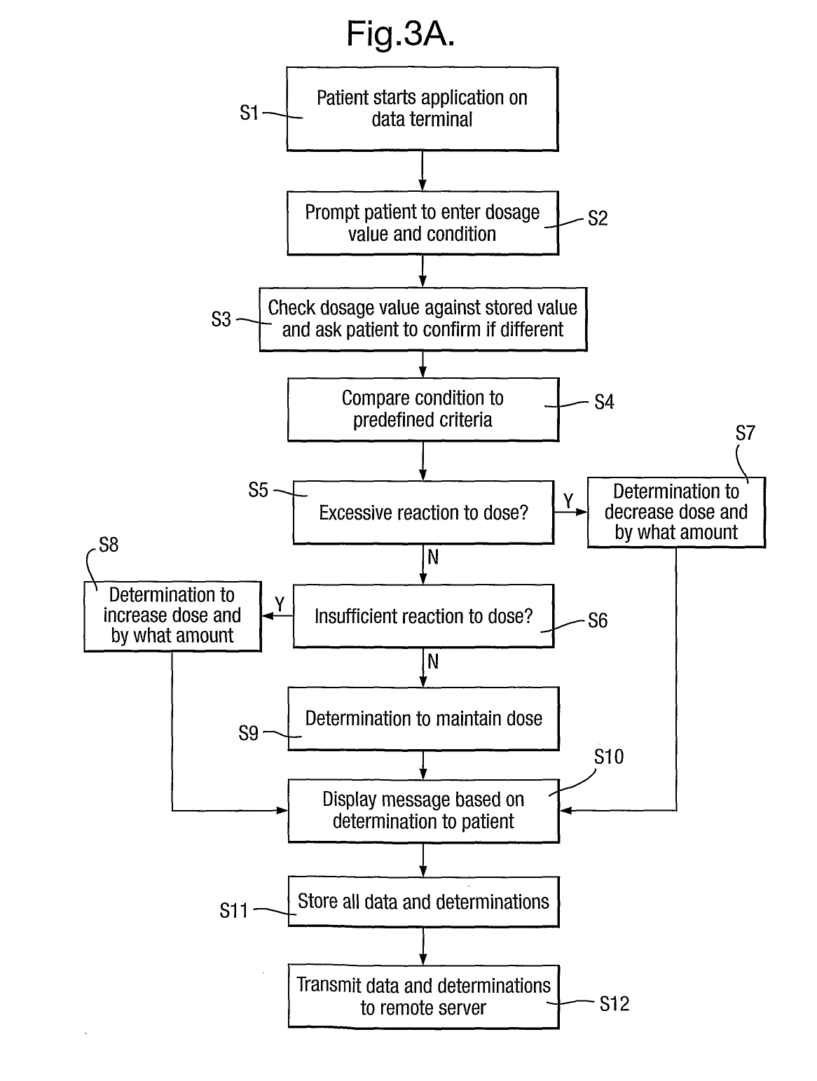

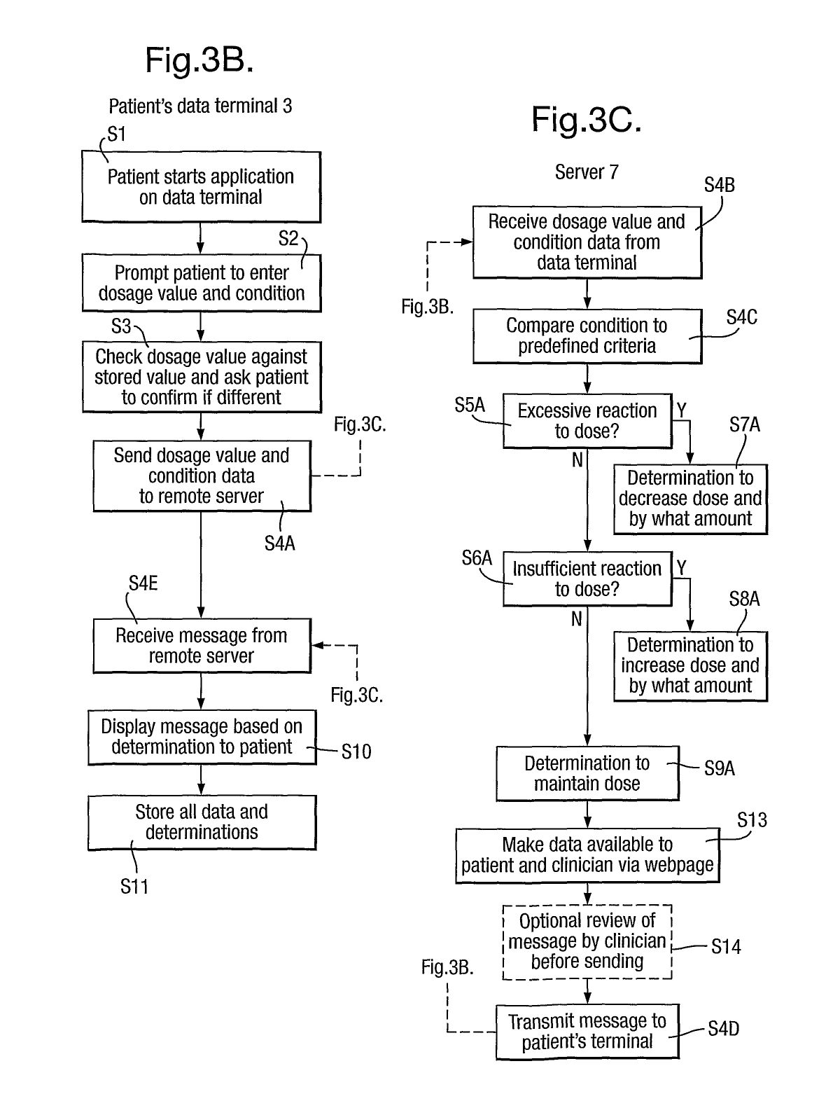

FIG. 3A is a flow diagram schematically illustrating the operation of a patient-based data terminal in accordance with one embodiment of the invention;

FIGS. 3B and C are flow diagrams schematically illustrating the operation of a patient-based data terminal and server in accordance with another embodiment of the invention;

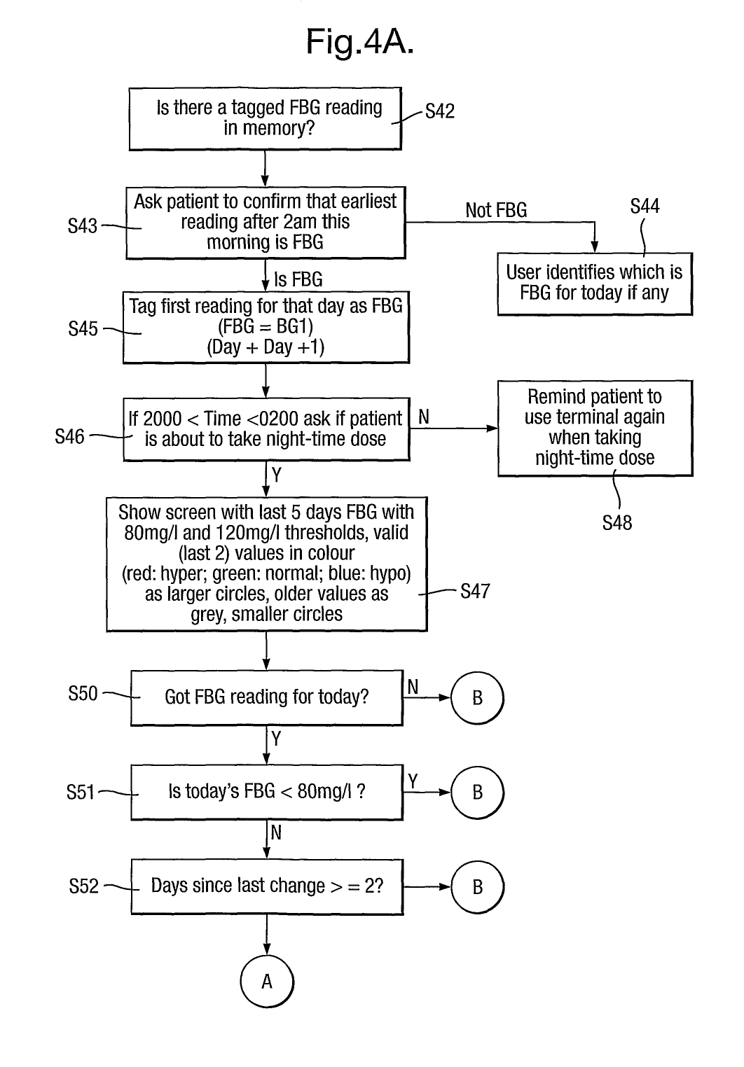

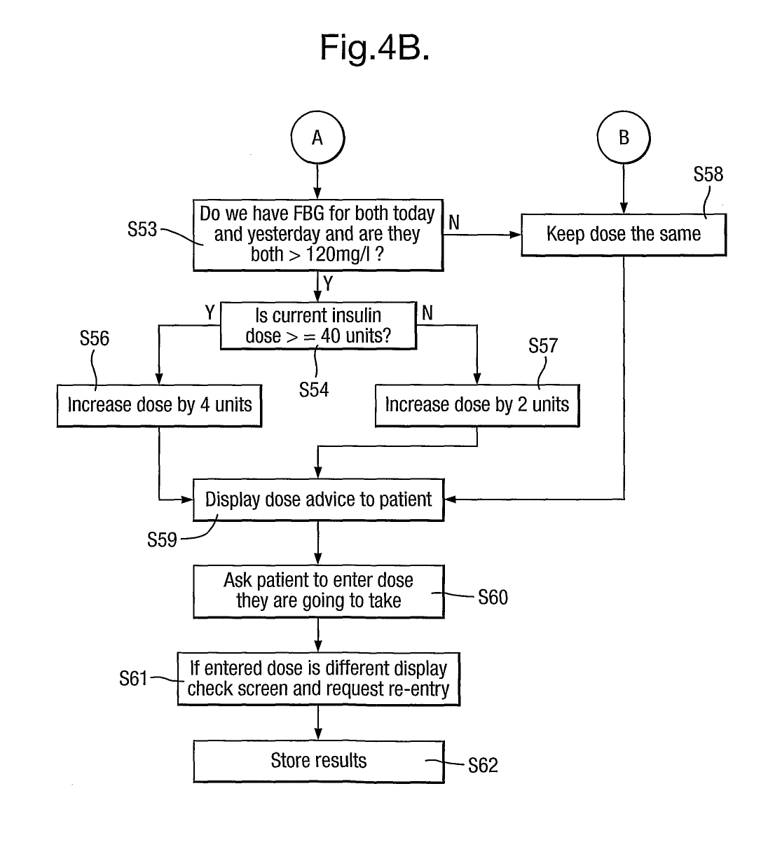

FIGS. 4A and B are flow diagrams illustrating the processing flow in accordance with an embodiment of the invention adapted for insulin titration;

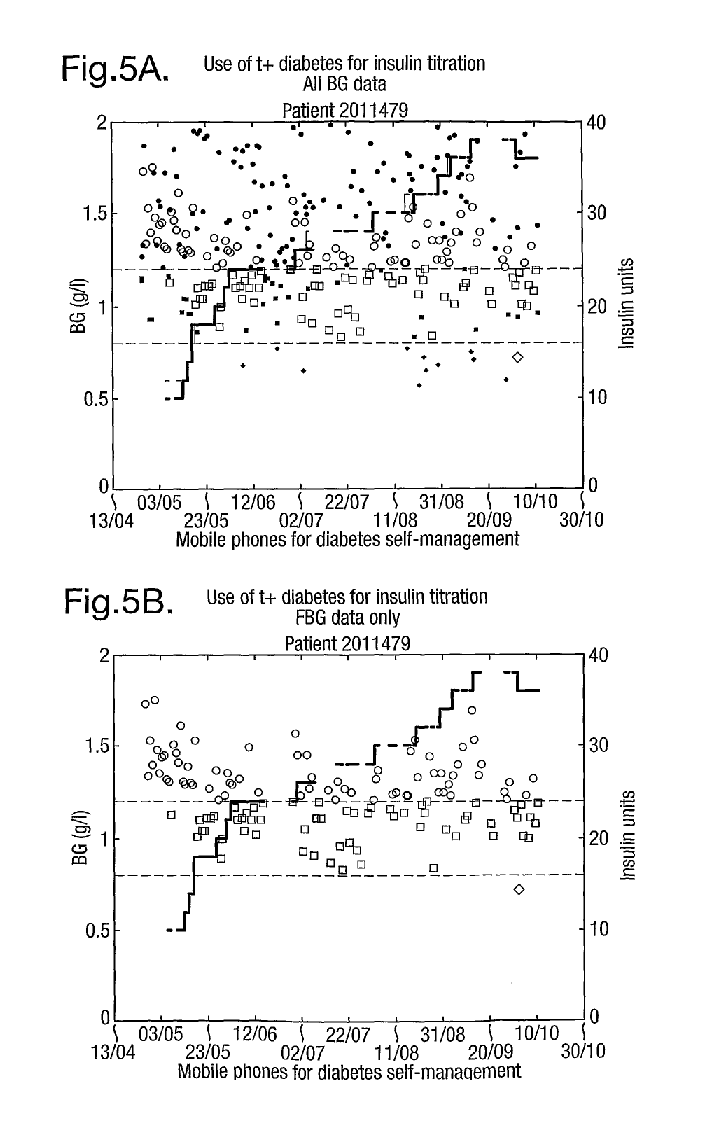

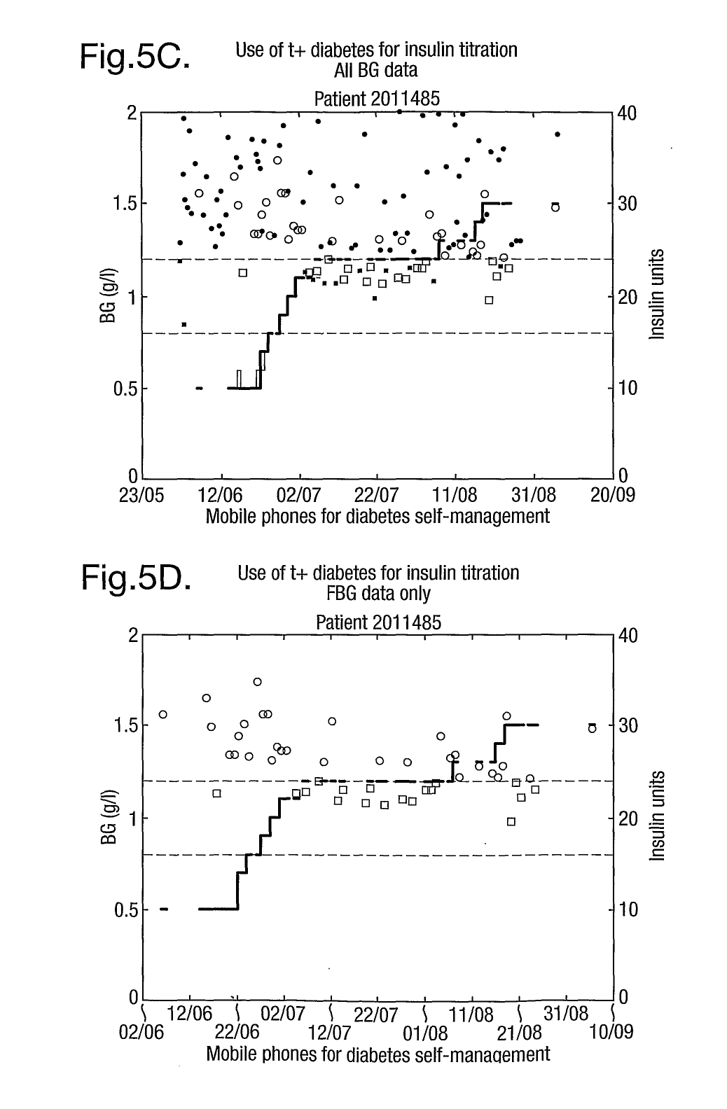

FIGS. 5A to D illustrate the way in which data is displayed on a web page to indicate the patient's condition and a dosage of insulin as entered by them;

FIG. 6 illustrates a display of fasting blood glucose values and thresholds in one example of the invention;

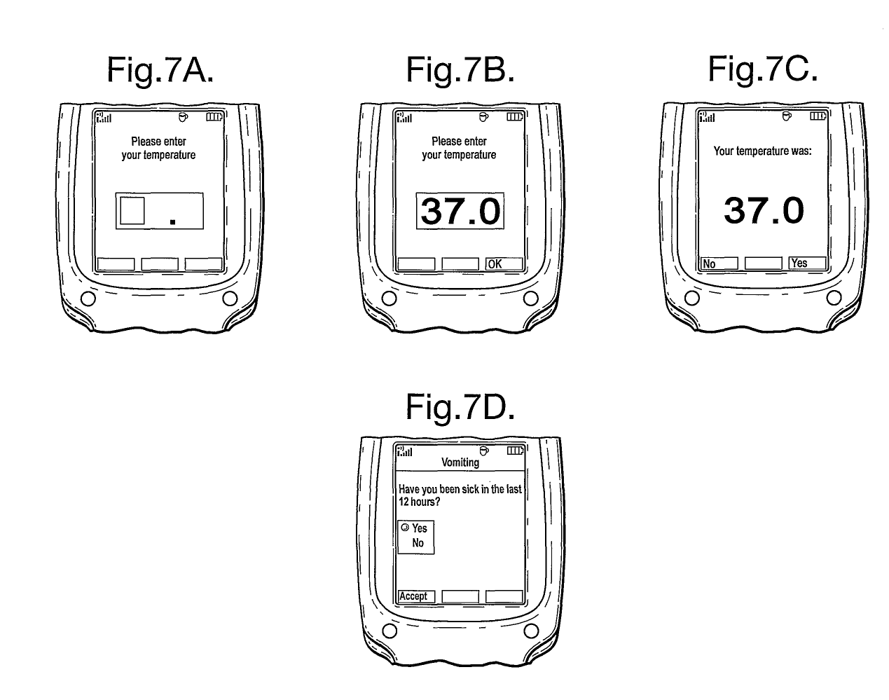

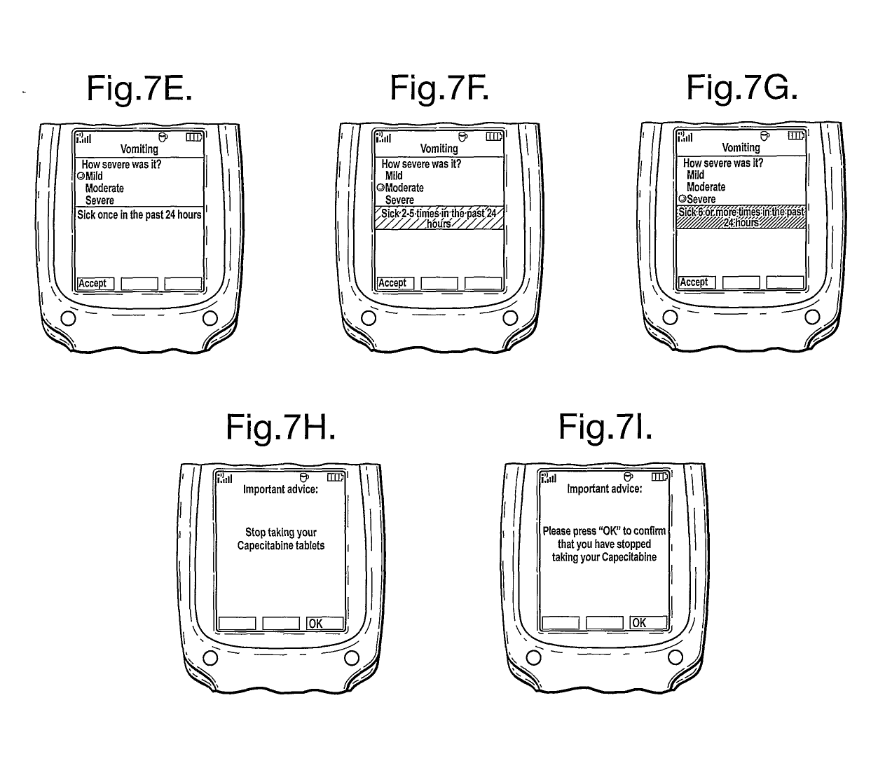

FIGS. 7A to I illustrate example screenshots for condition-indicative data entry by a patient in an embodiment of the invention for titration of a chemotherapy drug;

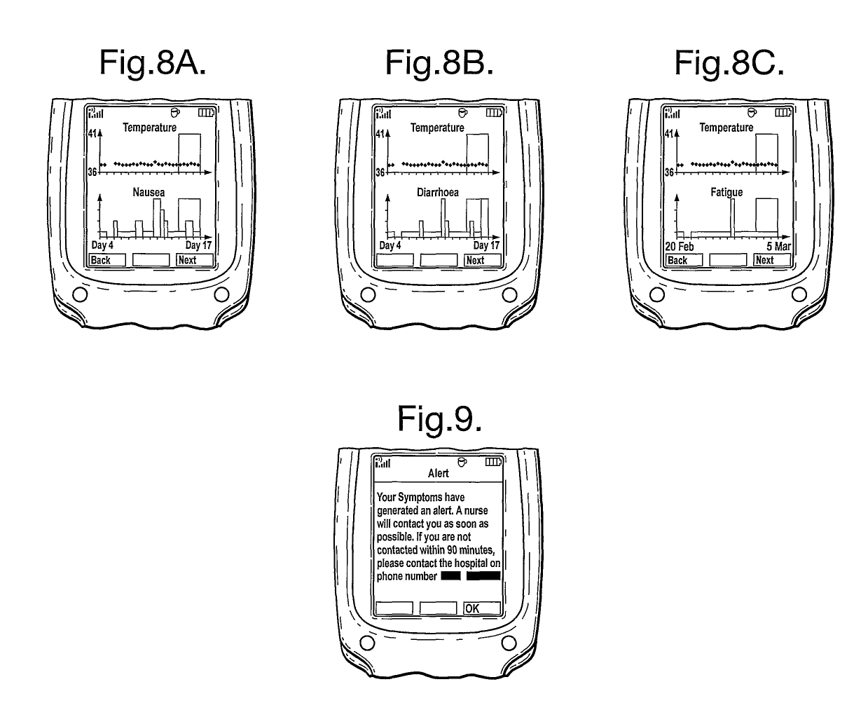

FIGS. 8A to C illustrate example screenshots of result summaries from an embodiment of the invention for titration of a chemotherapy drug;

FIG. 9 illustrates an example screenshot indicating generation of an alert in an embodiment of the invention for titration of a chemotherapy;

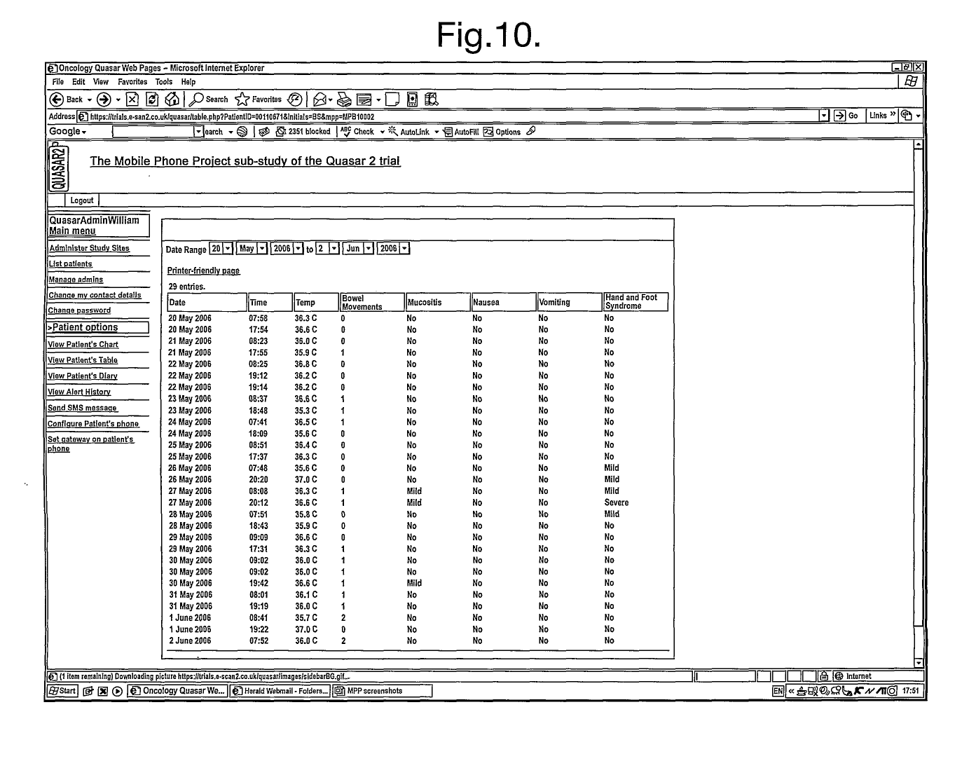

FIG. 10 illustrates an example screenshot of a webpage viewable by a clinician summarizing patient results in an embodiment of the invention for titration of a chemotherapy drug;

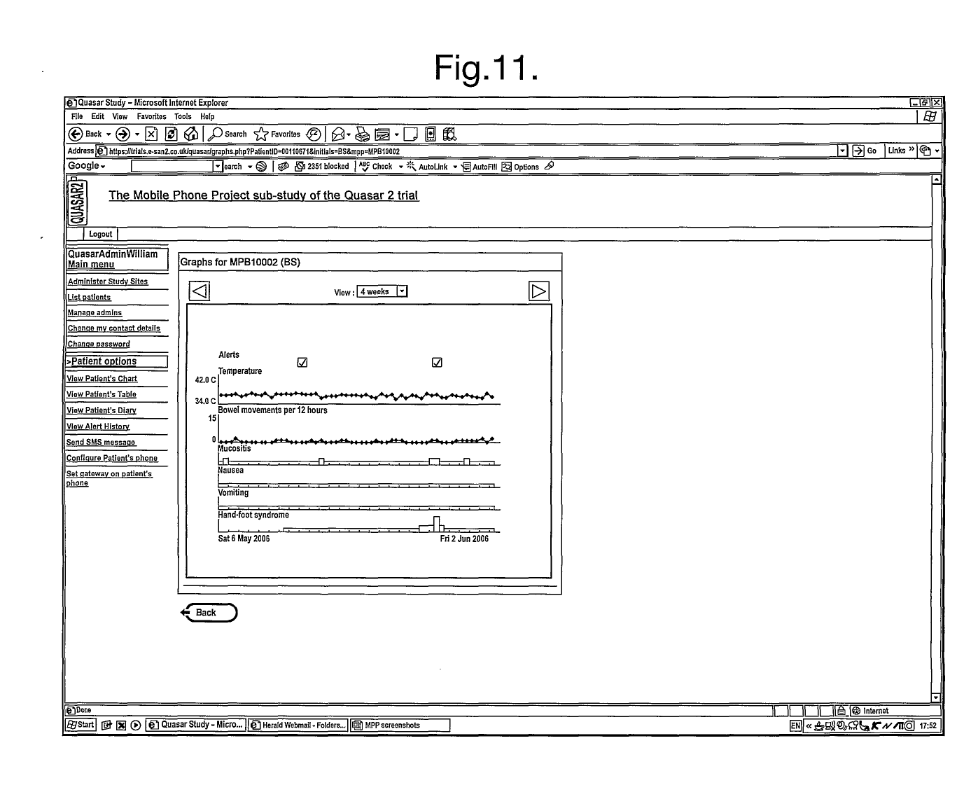

FIG. 11 illustrates an example screenshot of a webpage viewable by a clinician graphically illustrating patient results in an embodiment of the invention for titration of a chemotherapy drug; and

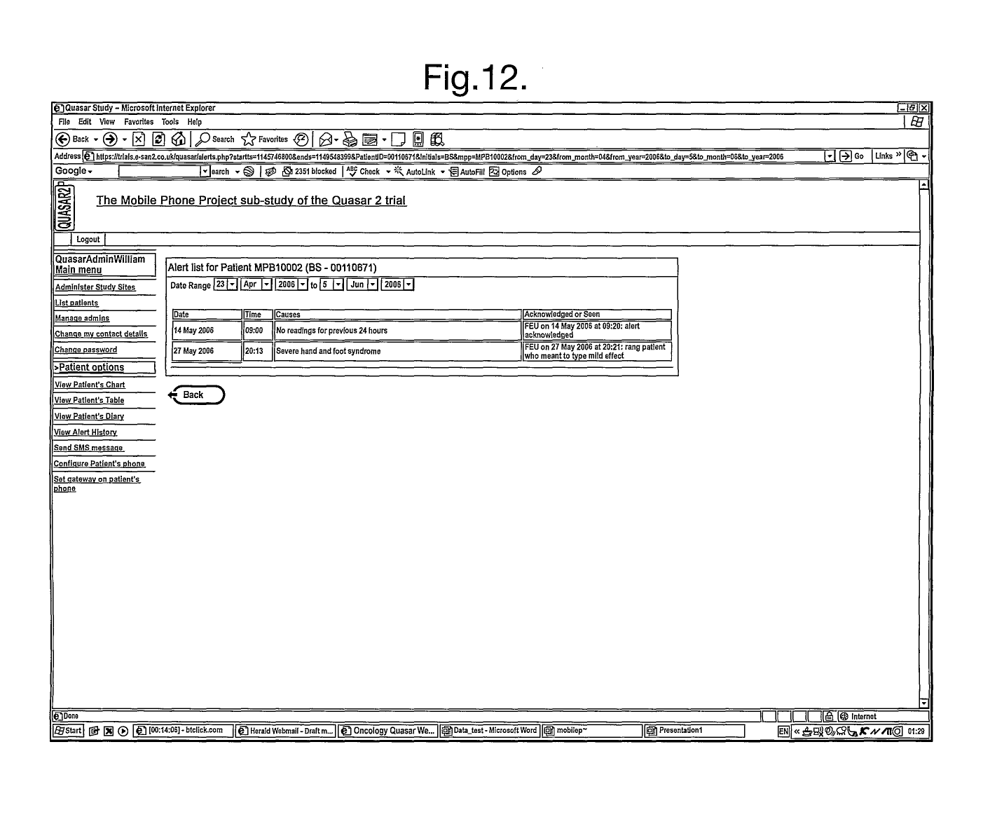

FIG. 12 illustrates an example screenshot of a webpage viewable by a clinician summarizing patient alerts in an embodiment of the invention for titration of a chemotherapy drug.

FIG. 1 schematically illustrates a system in accordance with one embodiment of the invention. As can be seen it comprises a patient-based data processing terminal 3 used by a patient 1 (in practice there would be a plurality of patients and patient-based data processing terminals). In this case the patient-based data processing terminal is a mobile telephone. The data terminal 3 is in communication via the internet 5 with a remote server 7 and the remote server 7 can make available via the internet web pages of data about the patient to a conventional personal computer 11 operated by a clinician 9. Optionally the system can include a pager 13 held by the clinician and used to receive the data either routinely or in the case of emergencies.

FIG. 2 illustrates schematically the patient-based terminal 3 which, as is conventional, has a keyboard 31 for allowing the patient to input data, a data processor 33, a display 35, a communications section 37 and a data store 39.

The invention, in this embodiment, is embodied as a software application running on the mobile telephone 3, with a corresponding software application on the remote server 7.

FIG. 3A illustrates an embodiment in which the software application running on the mobile telephone performs the dose optimisation process. In step S1 the patient starts the software application on the data terminal 3. At step S2 the data terminal 3 displays a message prompting the patient to enter the value of the dose of medication they propose to make and data indicative of their condition. The data indicative of their condition is provided either by entering the results of a measurement appropriate to the condition of the patient (in some cases this measurement can be transmitted directly from a measurement device to the data terminal 3), or can be entered by answering predefined questions displayed to the patient and, again, appropriate to their condition. Although the data terminal 3 maintains in its data store 39 a record of the currently recommended dosage, the patient may be asked to enter the proposed dose in step S2 by way of a check and to maintain the position that the patient is in control of the administration of the medication. Thus in step S3 the entered dosage value is entered against the stored value and the patient is asked to confirm the value if the two are different. It is the patient's value that is regarded as the correct current value.

In step S4 the data processor 33 compares the condition-indicative data entered by the patient to predefined criteria relating to the patient's condition. The data processor 33 then decides in steps S5 and S6 whether the reaction to the current dose is excessive or insufficient. In the case of excessive reaction (e.g. hypoglycaemic during insulin titration) it makes the determination in step S7 to decrease the dose, with the amount of decrease being decided by a comparison of the entered condition-indicative data to the predefined criteria. Similarly in the event of an insufficient reaction (e.g. high blood glucose levels during insulin titration) the data processor 33 determines in step S8 an increase in dosage, again by an amount based on the comparison. If the patient's reaction is neither excessive nor insufficient, the determination made by the processor 33 is to maintain the dose in step S9. Based on this determination, in step S10 a message is displayed on the display 35 of the patient-based data processing terminal advising the patient whether to maintain the dose or whether to increase or decrease it and by how much.

The criteria for deciding whether the patient's reaction is excessive or insufficient depend on the application and in some cases may be set by the clinician for the patient. For example, in the case of insulin titration fasting blood glucose levels of 6.7 and 4.4 mmol/litre may be set as the hyper- and hypoglycaemic thresholds, with the insulin dose being decreased by 2 units in the case of hypoglycaemia and increased by 2 units in the case of hyperglycaemia. The degree of difference from the threshold can be used to allow greater dosage changes, e.g. of 4 units, in the case of greater difference. In the case of chemotherapy using cytotoxic drugs, the severity of the side-effects may be used to maintain or decrease the dose: moderate side-effects no change, and severe side-effects a decrease of e.g. 10 or 15%.

The entered data and determinations are all stored in step S11 in the data store 39 and are transmitted by communications section 37 to the remote server in step S12.

Optionally the patient can be asked at the end of the process to enter the dosage they actually decide to administer to themselves.

The remote server 7 includes a software application for receiving the data transmitted in step S12, for storing it and processing it and making it available for display in web pages to the patient and to the clinician.

Optionally the data terminal 3 can include the facility to react to condition-indicative data indicating that the patient's condition is worsening by sending an alert to the remote server 7 which in turn alerts the clinician 9 via a pager 13. Such an alert could be, for example, to contact the patient immediately.

FIGS. 3B and 3C illustrate a variant in which the determination of dose adjustments is performed on the remote server 7 rather than the patient-based data processing terminal 3. As illustrated in FIG. 3B steps S1 to S3 performed on the patient-based data processing terminal 3 are unchanged, but in step S4A the dosage value and condition data are transmitted to the remote server 7. FIG. 3C illustrates the processing at the remote server. In step S4B the dosage value and condition data are received and in step S4C they are compared to predefined criteria to decide whether the patient's reaction to the current dose is insufficient, excessive or satisfactory. Steps S5A, S6A, S7A, S8A and S9A result in the determination to increase, decrease or maintain the dose as in steps S5 to S9 previously. In step S13 the data is made available for viewing by the patient and/or clinician on a web page (this step can be performed at the end of the processing if desired) and step S14 provides for an optional review of the message by a clinician before it is sent to the patient. Thus the clinician is able to decide whether or not the dosage should be adjusted in the manner determined by the algorithm. In step S4D the message is transmitted to the patient-based data processing terminal and on receipt there at step S4E it is displayed in step S10 and the data and determinations are stored in step S11 as before.

It should be noted that this embodiment can be further varied by requiring the clinician to contact the patient to advise on any dose adjustment, rather than having direct transmission of the message from the server to the patient-based data processing terminal 3. The choice of whether to adopt automatic dose optimisation based on processing at the patient-based data processing terminal as in FIG. 3A, or having the dose adjustment processing performed on the server as in FIGS. 3B and C depends on the capabilities of the patient-based data processing terminal and also the need to provide for clinician mediation in different circumstances. The embodiment of FIGS. 3B and 3C offer the option of clinician mediation of the advice and thus this may be appropriate for more serious conditions such as adjustment of the dose of chemotherapy drugs or insulin titration, whereas dose optimisation for less critical conditions such as asthma and hypertension may be less likely to need clinician mediation and thus appropriate for the patient-based processing as in FIG. 3A. The decision may also be based on the potential dangers of overdose or underdose of the medication. For this reason the decision to increase the dose of chemotherapy drugs will, in all likelihood, always require contact between patient and clinician.

Two specific examples of the application of the invention will now be given, one concerned with titration of cytotoxic drugs used in the treatment of cancer by chemotherapy and one in the treatment of insulin-dependent diabetes. In both cases a mobile telephone is used as the patient-based data processing terminal.

One example of an application of the invention is in the twice-daily symptom monitoring of patients undergoing treatment by oral administration of capecitabine which is a cytotoxic drug used for treating colorectal or breast cancer. Typical side effects monitored are diarrhoea and febrile neutropenia. Each time the patient takes their medication he/she is asked to start the application on the mobile telephone and is prompted to measure and enter their body temperature and to enter the number of bowel movements in the last twelve hours. FIGS. 7A to G illustrate example screenshots of a mobile telephone display during entry of data relating to temperature and vomiting. The patient's temperature and side-effects/symptoms are compared with predefined grading criteria, for example a simplified version of Common Terminology Criteria for Adverse events (CTCAE) set out in Table 1 below.

TABLE 1
Common Terminology Criteria for adverse events

| | Grade | | | | |
|---|---|---|---|---|---|
| Adverse Event | 1 | 2 | 3 | 4 | 5 |
| Diarrhoea | Increase of <4 stools/day | Increase of 4-6 stools/day | Increase of ≧7 stools/day | Life threatening | Death |
| | over baseline. | over baseline. | over baseline; incontinence. | consequences (e.g. | |
| | | | | haemodynamic | |
| | | | | collapse) | |
| Hand-foot Syndrome | Minimal skin changes or | Skin changes (e.g., peeling, | Ulcerative dermatitis or | — | |
| | dermatitis (e.g. erythema) | blisters, bleeding, edema) | skin changes with pain | | |
| | without pain | or pain, not interfering | interfering with function. | | |
| | | with function | | | |
| Haemoglobin (Hgb) | <LLN - 10.0 g/dL | 8.0 - <10.0 g/dL | 6.5 - <8.0 g/dL | <6.5 g/dL | Death |
| | <LLN - 100 g/L | 80 - <100 g/L | 65 - <80 g/L | <65 g/L | |
| | <LLN - 6.2 mmol/L | 4.9 - <6.2 mmol/L | 4.0 - <4.9 mmol/L | <4.0 mmol/L | |
| Mucositis | Minimal symptoms, | Symptomatic but can eat | Symptomatic and unable to | Symptoms | Death |
| | normal diet; minimal | and swallow modified diet; | adequately aliment or | associated with | |
| | respiratory symptoms but | respiratory symptoms | hydrate orally; respiratory | life-threatening | |
| | not interfering with | interfering with function | symptoms | consequences | |
| | function | | | | |
| Nausea | Loss of appetite without | Oral intake decreased | Inadequate oral caloric or | Life threatening | Death |
| | alteration in eating habits | without significant weight | fluid intake. | consequences | |
| | | loss, dehydration or | | | |
| | | malnutrition. | | | |
| Vomiting | 1 episode in 24 hrs | 2-5 episodes in 24 hrs. | ≧6 episodes in 24 hrs. | Life-threatening | Death |
| | | | | consequences | |

Key:
WNL Within normal limits
LLN Lower limit of normal
ADL Activities of daily living

For Pyrexia the corresponding criteria are:

| | | |
|---|---|---|
| Borderline pyrexia with | Grade 1 | reading in the range 37.5-37.9° C. |
| normal second reading | | and 2^{nd} reading (after 60 mins) |
| within 60 minutes | | is <37.5° C. |
| Borderline pyrexia for | Grade 2 | borderline pyrexia where 2^{nd} reading |
| 12 hours | | is also 37.5-37.9° C. |
| Pyrexia | Grade 3 | current temperature reading is |
| | | 38.0° C. or above |

As explained above the data entered by the patient is stored and sent to the remote server 7 where it can be accessed via the webpages such as those illustrated in FIGS. 10, 11 and 12, by the clinician 9 who is monitoring the patient's condition. The data entered by the patient can trigger amber or red alerts if the data indicates that the patient's condition is approaching or in a critical state, such alerts being sent to the clinician's pager 13. As well as an alert being sent to the clinician, the patient-based data processing terminal 3 also displays appropriate self-care advice, e.g. as shown in FIGS. 7H and I based on the symptoms which are of concern. Data summaries may also be displayed on the display of the mobile telephone as illustrated in FIGS. 8A to C. In the case of a red alert the mobile telephone may also indicate, as shown in FIG. 9, that the clinician will contact them within a mandated period.

A second example of an application of the invention will now be described, in this case to the titration of insulin dose for Type II diabetes. This example of the invention is provided as an addition to an existing commercially-available diabetes monitoring system which allows patients to enter blood glucose readings into their mobile telephone, from where they are transmitted to a remote server, processed and stored, and a display of blood glucose readings is made available to the patient both on the mobile telephone and as a web page.

For the purpose of titrating to an appropriate insulin dose it is the fasting blood glucose (FBG) reading which is required. This would normally be the first reading taken in the morning before breakfast. Based on this reading the dosage of insulin, normally taken once a day before bedtime, will be adjusted. FIGS. 4A and B illustrate that part of the process flow of the diabetes monitoring system which is concerned with dose titration. Firstly in steps S42 through S45 it is necessary to identify which of the blood glucose readings entered by the patient is the fasting blood glucose reading. Such a reading may already be tagged in the memory or the patient is asked to confirm that the earliest reading entered is an FBG reading or is asked to identify which is the FBG reading.

As the aim is to adjust the evening dose of insulin, in step S46 if the local time is between 8 p.m. and 2 a.m. the patient is asked whether this is their evening dose, and, if not, is requested in step S48 to re-use the data terminal when the evening dose is to be taken. If the patient confirms that they are about to take their evening dose of insulin, then in step S47 the data processor of the data terminal controls the display to show a history of the last five days' FBG readings with blood glucose thresholds indicated at 80 m g/l and 120 m g/l (4.4-6.7 mmol/l). Preferably the two most recent values are in colour with red indicating hyperglycaemia, green normal and blue hypoglycaemia. Older values can be indicated in grey, and as smaller circles. FIG. 6 illustrates such a display. It is then checked in step S50 whether there is a fasting blood glucose reading for today, and in steps S51 through S54: the FBG for today is compared to the thresholds, it is checked whether the dose has been changed in the last two days, and whether the current insulin dose is greater than or equal to 40 units. In steps S56, S57 an S58 the data processor determines whether to maintain the insulin dose or increase it, and if to increase then to increase by two units if the current dose is less than 40 units, or to increase by 4 if the current dose is equal to or greater than 40 units. (Of course other titration algorithms are available). This results in a recommended dose which is displayed to the patient in step S59. In step S60 through S61, following prompting of the patient to enter the dose they propose to take, it is checked whether the proposed dose is the same as the displayed dose. If not the patient is prompted to re-enter the dose they propose to take to confirm the amount. The dosages recommended and entered, and the patients condition are stored on the telephone and/or server at step S62.

FIGS. 5A to D show the blood glucose measurements and dosage values for two patients, in FIGS. 5A and B a patient with poor control and in FIGS. 5C and D a patient with better control. FIG. 5A illustrates all blood glucose data readings and the two thresholds together with a stepped line indicating how the insulin dosage changes. FIG. 5B illustrates the fasting blood glucose data points only, which are the points on which the dosage changes suggested by the titration algorithm are based. FIGS. 5C and D illustrate correspondingly all blood sugar data points and FBG data points for a patient with better control. The illustrations of FIGS. 5A to D are examples of the displays which are available via the web page provided by server 7. As indicated above the displays on the patient-based data processing terminal are simplified to include only a few previous readings as shown in FIG. 6.

1. A system for assisting in dose optimisation of medication, the system comprising:
a patient-based data processing terminal adapted to provide for periodic entry by the patient of predefined data indicative of their condition and of a current value of the dosage of medication associated with that condition that the patient is taking;
a data processor adapted to compare the entered data and dosage value with predefined criteria and to produce on the basis of the comparison a determination selected from adjusting or maintaining the dosage of medication;
a display adapted to display to a user a message based on said determination instructing the user to adjust or maintain the dosage of medication.

2. A system according to claim 1 wherein the patient-based data processing terminal is a mobile telephone or telephony-enabled personal digital assistant.

3. A system according to claim 1, wherein the data processor is provided in the patient-based data processing terminal.

4. A system according to claim 3 wherein the display on which the message is displayed is provided on the patient-based data processing terminal, whereby said user is the patient.

5. system according to claim 1, wherein the data processor is provided at a server remote from said patient-based data processing terminal.

6. A system according to claim 5 adapted to communicate said entered data and dosage values to said remote server and to communicate said message back to said patient-based data processing terminal for display thereon.

7. A system according to claim 6 wherein said user is a clinician, said system being adapted to display said message to said clinician before transmission to said patient-based data processing terminal.

8. A system according to claim 1, wherein the patient-based data processing terminal comprises a data store, and is adapted to store each entered dosage value and the result of each determination, and wherein the data processor is adapted to compare each dosage value on entry with the result of applying the most recent determination to the most recent stored dosage value and to control the display to display an alert to patient if they are different.

9. A system according to claim 1, wherein the patient-based data processing terminal is adapted to display to the patient a record of their condition data and of the dosage values.

10. A system according to claim 9 adapted to display the condition data and the dosage values on same display with good and bad condition data visually distinguishable from each other.

11. A system according to claim 1, wherein the patient-based data processing terminal is adapted to transmit the condition data and dosage values to a remote server together with any determinations made by a data processor on the patient-based data processing terminal.

12. A system according to claim 1, wherein the determination to adjust the dosage comprises determining whether the dosage should be increased or decreased.

13. A system according to claim 12 wherein the determination to adjust the dosage comprises determining whether the dosage should be increased or decreased by a amount which depends on a comparison of the entered data and dosage value with the predefined criteria.

14. A system according to claim 1, wherein the predefined condition-indicative data is the result of a measurement of the patient's condition.

15. A system according to claim 1, wherein the predefined condition-indicative data is the result of a subjective self-assessment by the patient.

16. A system according to claim 1, for use in the treatment of insulin-dependent diabetes wherein said message relates to the dosage of insulin to be taken by the patient.

17. A system according to claim 16, wherein the predefined condition-indicative data is a fasting blood glucose measurement.

18. A system according to claim 17 adapted to receive said fasting blood glucose measurement by direct transmission from a glycometer.

19. A system according to claim 1, for use in the titration of one or more cytotoxic drugs in treatment of cancer by chemotherapy.

20. A system according to claim 19 wherein the predefined condition-indicative data is data on the patient's reaction to said one or more cytotoxic drugs.

21. A system according to claim 20 wherein the predefined condition-indicative data is data on at least one of the patient's temperature, white blood cell count, blood pressure.

22. A system according to claim 20, wherein the predefined condition-indicative data is data on at least one of diahorrea or vomiting judged by the patient against predefined levels as mild, moderate or severe.

23. A system according to claim 22 adapted to display on a display in the patient-based data processing terminal definitions of said predefined levels.

24. A system according to claim 1, wherein the server comprises a web-server which makes available a web-page viewable by the patient and a web-page viewable by a clinician, each said web-page comprising a display of the condition data and of the dosage values.

25. A system according to claim 5, wherein said server is adapted to send data received from said plurality of patient-based data processing terminals to a clinician in batches.

26. A system according to claim 5, wherein said server is adapted selectively to send an emergency alarm to a clinician on receipt of emergency condition-indicative data from any one of said patient-based data processing terminals.

27. A system according to claim 24, wherein said server is adapted to send data received from said plurality of patient-based data processing terminals to a clinician in batches.

28. A system according to claim 24, wherein said server is adapted selectively to send an emergency alarm to a clinician on receipt of emergency condition-indicative data from any one of said patient-based processing terminals.
